(19) United States
(12) Patent Application Publication
(10) Pub. No.: US 2014/0356198 A1
(43) Pub. Date: Dec. 4, 2014

(54) Solar Powered Portable Submersible Water Pump

(71) Applicant: Flow Control LLC., Beverly, MA (US)

(72) Inventor: Samuel R. RULLI, Gloucester, MA (US)

(21) Appl. No.: 14/295,723

(22) Filed: Jun. 4, 2014

Related U.S. Application Data
(60) Provisional application No. 61/830,878, filed on Jun. 4, 2013.

(51) Int. Cl. F04B 17/00; F04B 23/04

(52) U.S. Cl. CPC F04B 17/006; F04B 23/04; F05B 2220/706; F05B 2240/97
USPC 417/360

(57) ABSTRACT

A pumping system for pumping water from streams, ponds or shallow wells having a predetermined depth, featuring a reel assembly to rotate so as to receive, roll-up and retain a hose; a submersible pump assembly having submersible pumps, each connected to a manifold in parallel so as to form a parallel pump configuration, the manifold having a hose connection to couple to the hose; a solar panel to couple and electrically power the submersible pump assembly; and a portable cart having a frame with a first frame part to affix to the reel assembly, a second frame part to affix to the solar panel, a third frame part to detachably receive and retain the submersible pump assembly, and a fourth frame part to affix to the wheel assembly to roll the pump system to a remote location for pumping water in areas with little or no access to grid electricity or liquid fuel.

### CROSS-REFERENCE TO RELATED APPLICATIONS

This application claims benefit to provisional patent application Ser. No. 61/830,878 (911-017.041-1//M-RLE-X0017), filed 4 Jun. 2013, which is incorporated by reference in their entirety.

### BACKGROUND OF THE INVENTION

1. Field of Invention

The present invention relates to a pump system; and more particularly to a pump system for use in remote areas having no access to an electric grid that supplies power.

2. Description of Related Art

In the prior art, there is a need to irrigate vegetation, and/or filter water in remote locations, e.g., by using solar power. These remote locations do not have access or have limited use of grid electricity or liquid fuel, therefore the need for solar powered devices is considered to be a must or critical requirement. The problem in the art is particularly acute in third world countries.

In view of this, there is a need in the prior art for an inexpensive solar driven pump that may be used to lift water from streams, ponds or shallow wells (e.g., which be on average about 60 feet deep) to crops or filtration units.

### SUMMARY OF THE PRESENT INVENTION

The present invention provides a new and unique solution to the aforementioned problem in the art. For example, the present invention provides a solar powered portable water pump or pump system that differs from known existing units by first having the option of a submersible pump, e.g., with two or more diaphragms assembled in parallel; second, providing the ability of using the submersible pump in a non-borehole application; third, using solar power; and fourth, by transporting all needed components on a portable unit, all consistent with that disclosed herein.

By way of example, and according to some embodiments, the present invention may include, or take the form of, apparatus such as a pump system for pumping water from streams, ponds or shallow wells having a predetermined depth, including an average of about 60 feet deep, featuring
a hose;
a reel assembly configured to rotate so as to receive, roll-up and retain the hose;
a submersible pump assembly having at least two submersible pumps, the at least two submersible pumps connected to a manifold in parallel so as to form a parallel pump configuration, the manifold having a hose connection configured to couple to one end of the hose;
at least one solar panel configured to couple electrically to the submersible pump assembly for powering the at least two submersible pumps;
a wheel assembly configured with at least one wheel; and
a portable cart having a frame with a first frame part configured to affix to the reel assembly, with a second frame part configured to affix to the at least one solar panel, with a third frame part configured to detachably receive and retain the submersible pump assembly, and with a fourth frame part configured to affix to the wheel assembly to roll the pump system to a remote location for pumping water in areas with little or no access to grid electricity or liquid fuel.

According to some embodiments, the present invention may also include one or more of the following features:

The at least two submersible pumps may include at least two diaphragm submersible pumps.

The submersible pump assembly may include a screen running down its entire length, so the pump can be placed horizontally in a stream or pond and not become clogged with dirt/debris.

The at least one solar panel may be foldable, including three solar panels that are foldable.

The at least one solar panel may be configured for directly powering the at least two submersible pumps with or without the use of a rechargeable battery.

The parallel pump configuration may be configured to increase flow but not head pressure, e.g., based at least partly on each diaphragm submersible pump being configured to produce enough pressure to lift water a desired predetermine height.

The wheel assembly may include two or more wheels.

The at least two submersible pumps may include, e.g., a centrifugal pump, a helical rotor pump, or a multistage diaphragm pump.

The pump system may also include a filtering unit configured to receive pumped water, filter it, and provide filtered water.

According to some embodiments, the present invention may include, or take the form of, a pump system for pumping water from streams, ponds or shallow wells having a predetermined depth, including an average of about 60 feet deep, featuring a hose; a hose reel configured to rotate so as to receive, roll-up and retain the hose; a diaphragm submersible pump assembly having at least two diaphragm submersible pumps, the at least two diaphragm submersible pumps connected to a manifold in parallel so as to form a parallel pump configuration that increases flow but not head pressure since said each diaphragm submersible pump produces enough pressure to lift water a desired predetermine height, the manifold configured to couple to one end of the hose; three solar panels configured to fold together during travel and unfold when being used, and also configured to couple electrically to the diaphragm submersible pump assembly for directly powering the at least two diaphragm submersible pumps without the use of a rechargeable battery; a wheel assembly configured with at least one wheel; and a portable cart a frame with a first frame part configured to affix to the reel assembly, with a second frame part configured to affix to the at least one of the three solar panels, with a third frame part configured to detachably receive and retain the submersible pump assembly, and with a fourth frame part configured to affix to the wheel assembly to roll the pump system to a remote location for pumping water in areas with little or no access to grid electricity or liquid fuel.

### BRIEF DESCRIPTION OF THE DRAWING

The drawing includes FIGS. 1-6, which are not necessarily drawn to scale, as follows:

FIG. 1 is a diagram of apparatus, e.g., in the form of a pump system having solar panels unfolded in an open position, according to some embodiments of the present invention.

FIG. 2 is a diagram of the apparatus shown in FIG. 1, having the solar panels folded up, according to some embodiments of the present invention.

FIG. 3 is a diagram of the apparatus shown in FIG. 1, having a submersible pump separate from a cart, according to some embodiments of the present invention.

FIG. 4 is a diagram of a submersible diaphragm pump assembly having a screen attached thereto, according to some embodiments of the present invention.

FIG. 5 is a diagram of a submersible diaphragm pump assembly without a screen attached thereto, according to some embodiments of the present invention.

FIG. 6 is a diagram of apparatus, e.g., in the form of a pump system having solar panels unfolded in an open position, according to some embodiments of the present invention.

### DETAILED DESCRIPTION OF BEST MODE OF THE INVENTION

### Overview

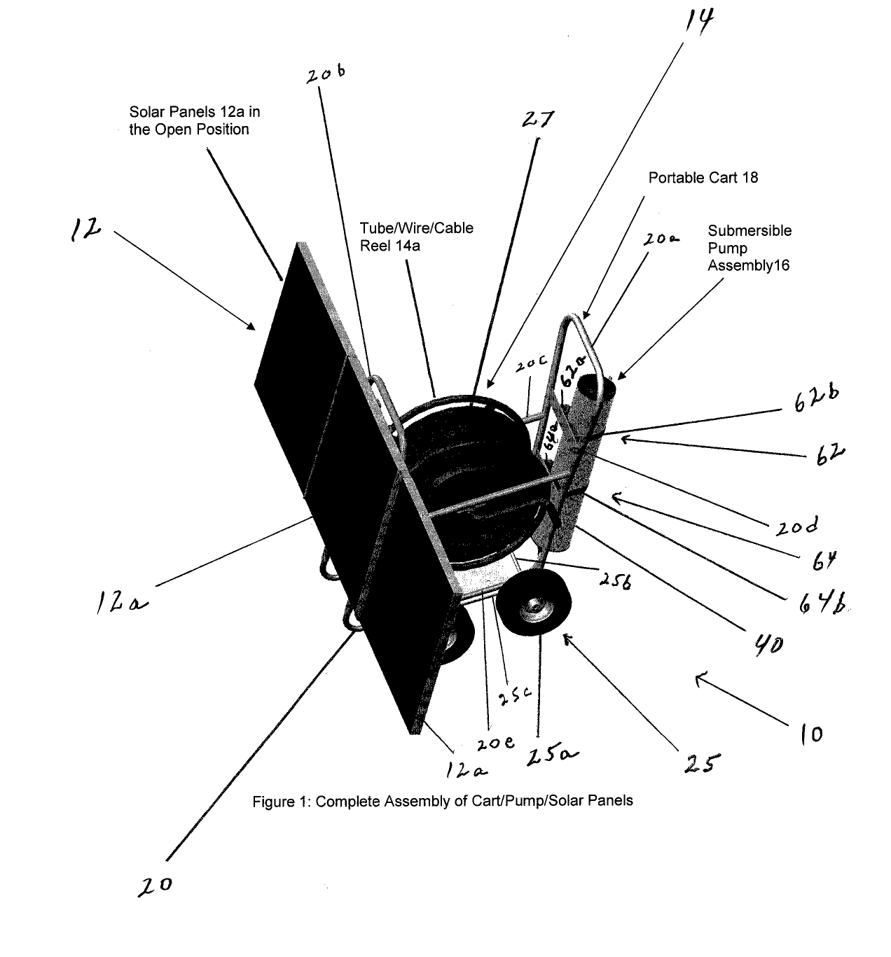

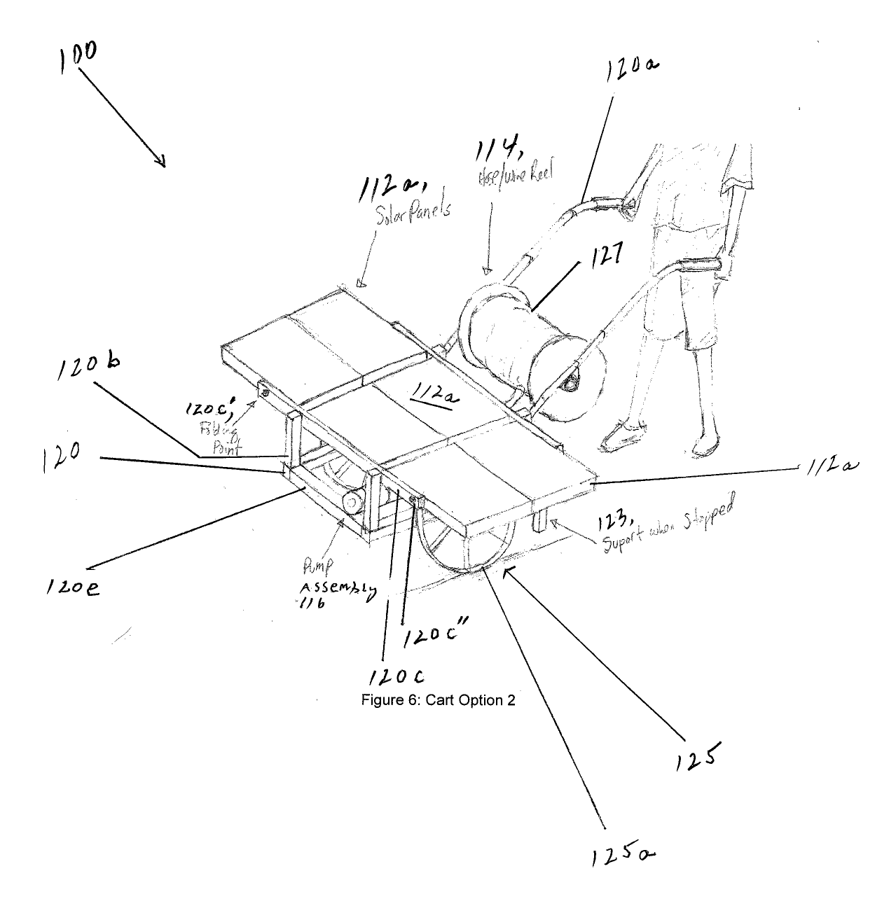

By way of example, FIGS. 1-6 show pump systems according to some embodiments of the present invention, for pumping water from streams, ponds or shallow wells having a predetermined depth, including an average of about 60 feet deep. The pump system in FIGS. 1-3 is generally indicated as 10, while the pump system in FIG. 6 is generally indicated as 100. Elements in FIG. 6 that are similar to corresponding elements in FIGS. 1-5 are labeled with similar reference numerals with the addition of “100.” Not every element in every Figure is indicated with a reference label and lead line so as to reduce clutter in the drawing.

In effect, the complete assembly of the pump system 10, 100 may be comprised of four major components: a solar panel assembly generally indicated as 12, 112 having one or more solar panels 12a, 112a; a reel assembly generally indicated as 14, 114 having a tube/wire/cable/hose reel 14a, 114a; a pump assembly generally indicated as 16, 116 having one or more submersible pumps 16a, 116a; and a cart or cart assembly 18, 118, e.g., as best shown in combination in FIGS. 1-3 and 6. The pump system 10, 100 is very portable when the solar panel assembly 12, 112, the reel assembly 14, 114 and the pump assembly 16, 116 are attached to the cart 18, 118 (e.g., see FIG. 1-2 or 6).

In FIGS. 1-3, the cart 10 is configured with a frame 20 having a wheel assembly generally indicated as 25 with four wheels 25a attached thereto. In comparison, in FIG. 6 the cart 100 is configured with a frame 120 having a wheel assembly 125 with two large wheels 125a attached thereto for optimal ground clearance, ergonomically correct handle bars 120a configured to be at waist height for an average person to stand inbetween, a solar panel support 120b, 120c mounted in or at an appropriate angle for maximum solar radiation exposure for the solar panels 112a, and the reel 114a configured between and mounted on the handle bars 120a at the correct height for the user. The scope of the invention is not intended to be limited to any particular number of wheels, and embodiments are envisioned having other wheel configurations than that shown in FIGS. 1-3 and 6, e.g., including one wheel, three wheels, etc.

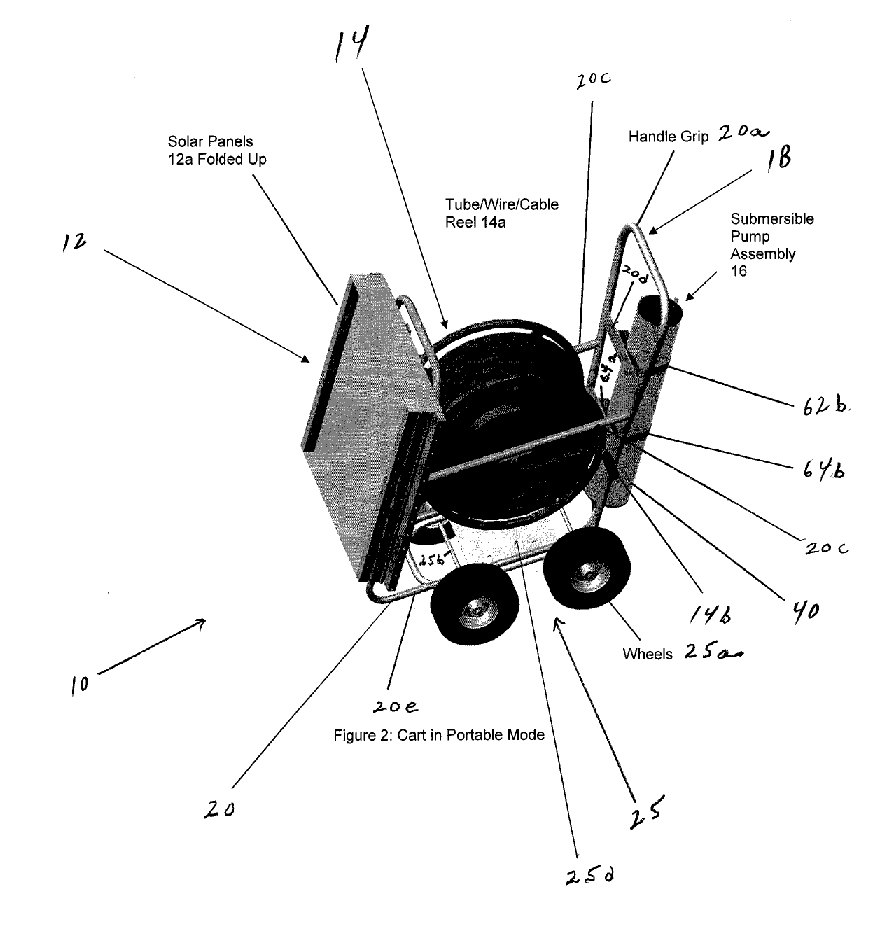

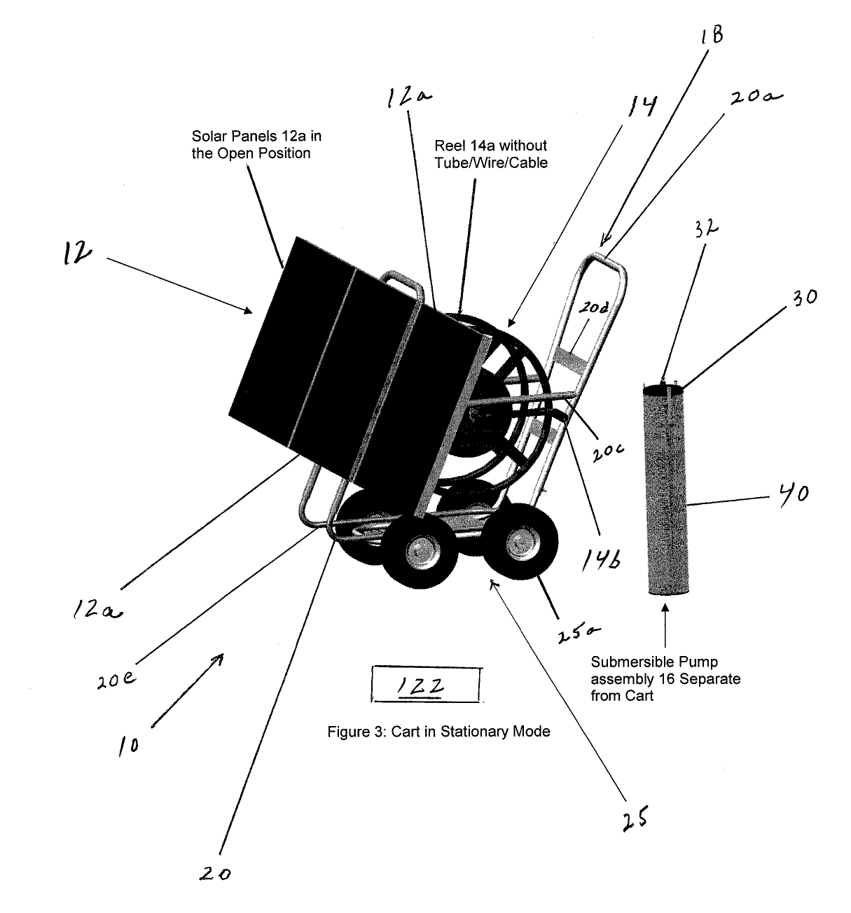

The operator can easily transport the pump system 10, 100 by rolling it from his/her storage space to a source of water, e.g., with the three solar panels 12a typically folded up, as shown in FIG. 2. Once the pump system 10, 100 is in the correct location, the solar panels 12a, 112a may be folded out and the submersible pump assembly 16, 116 can be removed from the cart 18, 118 (see FIG. 3).

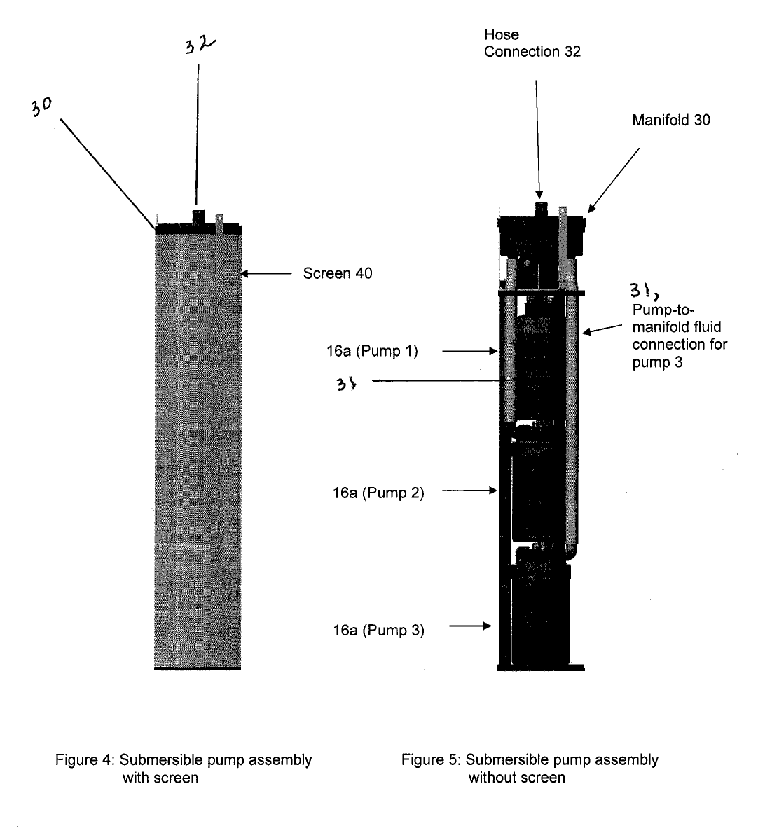

Next, the submersible pump assembly 16, 116 may be lowered into the supply water, while the reel 14, 114 would be operated to unwind the bundle of hose or hosing 27, 127 for coupling one end to a hose connection 32 (see FIGS. 4-5) of the submersible pump assembly 16, 116.

The pump system 10, 100 may be configured so as to have the solar panels 12a, 112a directly running the pumps (e.g., pumps 16a in FIG. 5) in the submersible pump assembly 16, 116 (no battery included), so the cart 18, 118 would need to be pointed towards the sun to get the highest water output. Alternatively, the pump system 10, 100 may be configured with a rechargeable battery 122 directly running the pumps in the submersible pump assembly 16, 116, where the solar panels 12a, 112a are configured to recharge the rechargeable battery 122. A person skilled in the art would appreciate and understand how to implement embodiments so as to electrically power the submersible pump assembly 16, 116 using the solar panel assembly 12, 112 with or without a rechargeable battery, and the scope of the invention is not intended to be limited to any particular implementation either now known or later developed in the future.

A multitude of different submersible pumps like element 16a (FIG. 5) can be used in the pump system, for example: including centrifugal, helical rotor, or multistage diaphragm pumps. For example, a multistage diaphragm pump may be made of, or configured with, two or more submersible diaphragms connected to a manifold 30 in parallel (see FIG. 5 for an example of a three diaphragm pump). The parallel pump configuration increases flow but not head pressure, e.g., because one diaphragm pump can already be configured to produce enough pressure to lift water for the intended application of the present invention. The submersible pump assembly 16, 116 can be placed horizontally or at any angle in a stream or pond and still not become clogged from dirt/debris (see FIG. 4) by incorporating a screen 40 as part of the submersible pump assembly 16, 116 that runs down its entire length and by having a multitude of smaller inlets on the inside of the screen 40. The screen 40 creates a large area of small holes, so if one small area of the screen 40 becomes clogged the water can be pulled from the non-clogged area (see FIG. 5).

With this backdrop, FIGS. 1-6 will be described in further detail.

FIGS. 1-3

In particular, in FIGS. 1-3 the frame 20 includes at least the following:
a handle grip or part (or parts) 20a configured on the back end of the cart 18;
a solar panel support part (or parts) 20b configured on the front end of the cart 18;
a reel support part (or parts) 20c coupled between the handle part 20a and the solar panel support part 20b on the top side of the cart 18;
a submersible pump assembly support part (or parts) 20d coupled to the handle part 20a; and
a wheel support part (or parts) 20e coupled between the handle part 20a and the solar panel support part 20b on the bottom side of the cart 18.

The frame 20 may be made of a lightweight or durable metal or plastic, although the scope of the invention is not intended to be limited to any particular type or kind of material. In particular, according to some embodiments, the aforementioned parts 20a, 20b, 20c, 20d, 20e of the frame 20 may be made of metal piping that is welded together. The metal piping may be made from rustproof metals, e.g., including stainless steel, etc. Alternatively, according to some embodiments, the aforementioned parts 20a, 20b, 20c, 20d, 20e of the frame 20 may be made of plastic piping or tubing, e.g., that is molded together as an integral unit.

The reel support part 20c may be configured to receive and retain the reel assembly 14 to the frame 20 of the cart 18, e.g., so that the reel 14a can rotate so as to receive, roll-up and retain the hose or hosing 27, e.g., by turning or rotating a handle 14b. Consistent with that shown in FIGS. 1-3. the reel 14a may be configured or adapted from a standard garden hose reel that is known in the art, as well as reels using in relation to tubes, wire, cable, etc. The reel 14a may be suitably coupled to the reel support part 20c, e.g., using fasteners or fastener assemblies that are known in the art, etc., as would be appreciated by a person skilled in the art.

The solar panel support part 20b may be configured to affix to the at least one solar panel 12a, e.g., by using fasteners or fastener assemblies that are known in the art, to the frame 20 of the cart 18. Consistent with that shown in FIGS. 1-3, the solar panel assembly 12 includes three solar panels, each labeled 12a, that are coupled together, e.g., using a hinge assembly, as would be appreciated by a person skilled in the art. Hinge assemblies for coupling two panels together, like two solar panels 12a, are known in the art, and the scope of the invention is not intended to be limited to any particular type or kind thereof either now known or later developed in the future. As shown in FIGS. 1-3, the middle solar panel 12a is affixed to the solar panel support part 20b, and the two end solar panels 12a are coupled to the middle solar panel so as to be foldable. Techniques for coupling a flat back surface of a solar panel like element 12a to piping like the solar panel support part 20b are known in the art, and the scope of the invention is not intended to be limited to any particular type or kind of technique either now known or later developed in the future. By way of example, the solar panel support part 20b may be configured with an aperture for receiving a fastener that screws into the back surface of the solar panel. Alternatively, a pipe coupling fastener having a curved intermediate portion and two apertures for receiving fasteners may be fitted over the solar panel support part 20b and the fasteners passed through apertures and screwed into the back surface of the solar panel on both sides of the piping for coupling the solar panel 12a to the solar panel support part 20b.

The submersible pump assembly support part 20d may be configured to detachably receive and retain the submersible pump 16a to the frame 20 of the cart 18, consistent with that shown in FIGS. 1-2. For example, upper and lower strap assemblies generally indicated as 62, 64, each having a mounting member 62a, 64a and mounting straps 62b, 64b, may be configured to couple the submersible pump 16a to the submersible pump assembly support part 20d, consistent with that shown in FIGS. 1-2. Each mounting member 62a, 64a may be fastened to the submersible pump assembly support part 20d, e.g., using fasteners like metal screws.

The wheel support part 20e may be configured with the wheel assembly 25 attached thereto to roll the pump system 10 to a remote location for pumping water in areas with little or no access to grid electricity or liquid fuel. Consistent with that shown in FIGS. 1-2, the wheel assembly 25 may include the wheels 25a, axles 25b, a base part 25c and suitable fasteners (not shown) for coupling the wheel assembly 25 to the wheel support part 20e. The wheel assembly 25 may also include a table portion 25d coupled to the base part 25c, e.g., for coupling a rechargeable battery 122 (see FIG. 3) thereto.

In FIGS. 1-3, the hosing or hose 27 may be wound onto the reel 14, for storage, and unwound in whole or in part during use. The hosing or hose 27 may be configured with suitable couplings on each end, e.g., for coupling on one end to the hose connection 32 (e.g., see FIGS. 4-5) on the manifold 30 of the submersible pump assembly 16, and for coupling the other end, e.g., to a nozzle (not shown) for controlling the spraying of the water being pumped. The scope of the invention is not intended to be limited to any particular type or kind of hose or hosing, or any particular type or kind of hose end couplings either now known or later developed in the future.

FIGS. 1-2 show the submersible pump assembly 16 attached to the cart 18 using the upper and lower strap assemblies 62, 64, and FIGS. 3-5 show the submersible pump assembly 16 detached from the cart 18.

FIGS. 4-5 show the submersible pump assembly 16 with and without the screen 40. Consistent with that shown in FIGS. 1-4, the screen 40 may be configured to run down the entire length of the submersible pump assembly 16, so it can be placed horizontally in a stream or pond and not become clogged with dirt/debris. Consistent with that shown in FIG. 5, the submersible pump assembly 16 may be configured with multiple submersible pumps 16a, e.g., including pump 1, pump 2, pump 3 as indicated. Each pump 16a is coupled or connected via tubing or piping 31 to the manifold 30 in parallel so as to form the parallel pump configuration. (In FIG. 5, the tubing or piping 31 is shown for pump 1 and pump 3; however, the tubing or piping 31 for pump 2 is in the back of the multiple pump configuration and is not clearly visible in FIG. 5.) In operation, the hose connection 32 of the manifold 30 is coupled to the hose or hosing 27.

FIG. 6

FIG. 6 shows an alternative pump system 100, according to some embodiments of the present invention. The pump system 100 has three of the four major components, including the solar panel assembly 112, the reel assembly 114 and the pump assembly 116, all arranged on different parts of the cart 118 than that shown in FIGS. 1-3.

For example, the pump system 100 has the solar panels 112a configured or arranged on the frame parts 120b,120c on the top of the cart 118, instead of on the front part of the cart as shown in FIG. 1-3. The reel assembly 114 is configured between the handle bars or parts 120a, instead of in the middle of the cart as shown in FIGS. 1-3. The pump assembly 116 is configured in the lower part of the cart 118, instead of on the back of the cart as shown in FIG. 1-3.

In FIG. 6, the frame part 120c is shown having two folding pivots 120c′, 120c″, configured to allow the two end solar panels 112a to be folded in relation to the middle solar panel 112a. The two end solar panels 112a may also be configured with suitable supports 123 for lowering to provide additional support for the solar panels once unfolded.

### The Scope of the Invention

While the invention has been described with reference to an exemplary embodiment, it will be understood by those skilled in the art that various changes may be made and equivalents may be substituted for elements thereof without departing from the scope of the invention. In addition, may modifications may be made to adapt a particular situation or material to the teachings of the invention without departing from the essential scope thereof. Therefore, it is intended that the invention not be limited to the particular embodiment(s) disclosed herein as the best mode contemplated for carrying out this invention.

What I claim is:

1. A pump system for pumping water from streams, ponds or shallow wells having a predetermined depth, including an average of about 60 feet deep, comprising:
a hose;
a reel assembly configured to rotate so as to receive, roll-up and retain the hose;
a submersible pump assembly having at least two submersible pumps, the at least two submersible pumps connected to a manifold in parallel so as to form a parallel pump configuration, the manifold having a hose connection configured to couple to one end of the hose;
at least one solar panel configured to couple electrically to the submersible pump assembly for powering the at least two submersible pumps; and
a portable cart having a frame with a first frame part configured to affix to the reel assembly, with a second frame part configured to affix to the at least one solar panel, with a third frame part configured to detachably receive and retain the submersible pump assembly, and with a fourth frame part configured to affix to the wheel assembly to roll the pump system to a remote location for pumping water in areas with little or no access to grid electricity or liquid fuel.

2. A pump system according to claim 1, wherein the at least two submersible pumps comprises at least two diaphragm submersible pumps.

3. A pump system according to claim 1, wherein the submersible pump assembly comprises a screen running down its entire length, so the pump can be placed horizontally in a stream or pond and not become clogged with dirt/debris.

4. A pump system according to claim 1, wherein the at least one solar panel is foldable.

5. A pump system according to claim 4, wherein the at least one solar panel comprises three solar panels that are foldable.

6. A pump system according to claim 1, wherein the at least one solar panel is configured for directly powering the at least two submersible pumps without the use of a battery.

7. A pump system according to claim 1, wherein the parallel configuration is configured to increase flow but not head pressure, based at least partly on said each submersible pump being configured to produce enough pressure to lift water a desired predetermine height.

8. A pump system according to claim 1, wherein the at least one wheel comprises two wheels.

9. A pump system according to claim 1, wherein the at least two submersible pumps comprises three diaphragm submersible pumps.

10. A pump system according to claim 1, wherein the at least two submersible pumps comprises a centrifugal pump, a helical rotor pump, or a multistage diaphragm pump.

11. A pump system according to claim 1, wherein the pump system comprises a water filtering unit configured to receive pumped water, filter it, and provide filtered water.

12. A pump system for pumping water from streams, ponds or shallow wells having a predetermined depth, including an average of about 60 feet deep, comprising:
a hose;
a hose reel configured to rotate so as to receive, roll-up and retain the hose;
a diaphragm submersible pump assembly having three diaphragm submersible pumps, the three diaphragm submersible pumps connected to a manifold in parallel so as to form a parallel configuration that increases flow but not head pressure since said each diaphragm submersible pump produces enough pressure to lift water a desired predetermine height, the manifold configured to couple to the hose;
three solar panels configured to fold together during travel and unfold when being used, and also configured to couple electrically to the diaphragm submersible pump assembly for directly powering the at least two diaphragm submersible pumps without the use of a battery; and
a portable cart having a frame with a first frame part configured to affix to the reel assembly, with a second frame part configured to affix to at least one of the three solar panels, with a third frame part configured to detachably receive and retain the submersible pump assembly, and with a fourth frame part configured to affix to the wheel assembly to roll the pump system to a remote location for pumping water in areas with little or no access to grid electricity or liquid fuel.

13. A pump system for pumping water from streams, ponds or shallow wells having a predetermined depth, including an average of about 60 feet deep, comprising:
a hose;
a reel assembly configured to rotate so as to receive, roll-up and retain the hose;
a submersible pump assembly having at least one submersible pump, the at least one submersible pump having a hose connection configured to couple to one end of the hose;
at least one solar panel configured to couple electrically to the submersible pump assembly for powering the at least one submersible pump; and
a portable cart having a frame with a first frame part configured to affix to the reel assembly, with a second frame part configured to affix to the at least one solar panel, with a third frame part configured to detachably receive and retain the submersible pump assembly, and with a fourth frame part configured to affix to the wheel assembly to roll the pump system to a remote location for pumping water in areas with little or no access to grid electricity or liquid fuel.
